(19) United States
(12) Patent Application Publication
(10) Pub. No.: US 2008/0061259 A1
(43) Pub. Date: Mar. 13, 2008

(54) ANTI-LEAK ADAPTOR FOR USE IN A VEHICLE AIR CONDITIONING SYSTEM TEST

(75) Inventor: ALBERTO N. REGINALDO, Orchard Lake, MI (US)

Correspondence Address: GIFFORD, KRASS, SPRINKLE,;ANDERSON & CITKOWSKI, P.C., P.O. BOX 7021, TROY, MI, 48007-7021, US

(73) Assignee: Toyota Engineering & Manufacturing North America, Inc., Erlanger, KY (US)

(21) Appl. No.: 11/530,044

(22) Filed: Sep. 8, 2006

(51) Int. Cl. F16L 29/00

(52) U.S. Cl. 251/148

(57) ABSTRACT

An anti-leak adaptor for use in a vehicle during an air conditioning system evaluation includes a cylindrically shaped adaptor body having a first end and a second end. A central passageway extends between an opening in the first end to an opening in the second end. The first end includes a guide portion and a threaded portion that is adjacent the guide portion. A knob is positioned on a mid-portion of the adaptor body, and the knob is operatively connected to a plunger disposed within the central passageway in the adaptor body and oriented longitudinally towards the opening in the first end. A fitting is connected to the second end of the adaptor body for receiving a sensing means.

### BACKGROUND OF THE INVENTION

1. Field of the Invention

The present invention relates generally to in-vehicle air conditioning system testing, and more specifically, to an anti-leak adaptor for use during an in-vehicle air conditioning system test.

2. Description of the Related Art

Vehicles, and in particular motor vehicles, frequently include an air conditioning system, that is part of the climate control system providing conditioned air to the interior compartment of the vehicle. The air conditioning system is a closed system that involves the circulation of a refrigerant through lines interconnecting various components, such as a compressor, condenser, an evaporator, a pressure regulator or valves, or the like. Although various refrigerants are known in the art, R134a is currently utilized for automotive applications. Environmental regulations stipulate the type of refrigerant utilized on a vehicle, as well as potential environmental exposure, to minimize any environmental harm.

At various times during the design, development or life of a vehicle, it may be necessary to evaluate the function of the vehicle air conditioning system. For example, the air conditioning system evaluation may take place in a specially designed environmental test chamber, or a dynamic test on the road. In order to evaluate the air conditioning system function, an access port such as a service valve is disposed in one of the lines. While these types of service valves work well, there is the potential for a leakage of the refrigerant through a connection between the service valve and another component. Therefore, it is desirable to utilize an anti-leak adaptor that connects to the current in-line service valve, in order to minimize leakage through the service valve when the service valve is accessed.

### SUMMARY OF THE INVENTION

Accordingly, the present invention is an anti-leak adaptor for use with a vehicle during an air conditioning system evaluation. The anti-leak adaptor includes a cylindrically shaped adaptor body having a first end and a second end. A central passageway extends between an opening in the first end to an opening in the second end. The first end includes a guide portion and a threaded portion that is adjacent the guide portion. A knob is positioned on a mid-portion of the adaptor body, and the knob is operatively connected to a plunger disposed within the central passageway in the adaptor body and oriented longitudinally towards the opening in the first end. A fitting is connected to the second end of the adaptor body for receiving a sensing means.

One advantage of the present invention is that an anti-leak adaptor is provided that decreases the amount of refrigerant leakage through the service valve when evaluating the air conditioning system of the vehicle. Another advantage of the present invention is that an anti-leak adaptor is provided that eliminates the need for a separate pressure gauge during an evaluation of the air conditioning system. Still another advantage of the present invention is that an anti-leak adaptor is provided that offers operator controlled access to the air conditioning system through the service valve. A further advantage of the present invention is that an anti-leak adaptor is provided that can be utilized under various test conditions in order to evaluate the air conditioning system. Still a further advantage of the present invention is that an anti-leak adaptor is provided that is cost effective to manufacture and is readily adaptable to different vehicles and types of air conditioning systems.

Other features and advantages of the present invention will be readily appreciated, as the same becomes better understood after reading the subsequent description taken in conjunction with the accompanying drawings.

### BRIEF DESCRIPTION OF THE DRAWINGS

FIG. 1 is a diagrammatic view of a refrigerant system for a vehicle, according to the present inventions.

FIG. 2 is an elevational view of an embodiment of an anti-leak adaptor and service valve for the refrigerant system of FIG. 1, according to the present inventions.

FIG. 3 is a perspective view of another embodiment of an anti-leak adaptor for the refrigerant system of FIG. 1, according to the present inventions.

FIG. 4 is a side view of the anti-leak adaptor of FIG. 3, according to the present inventions.

FIG. 5 is a sectional view of the anti-leak adaptor of FIG. 4 taken along lines 5-5, according to the present inventions.

FIG. 6 is a perspective view of yet another embodiment of an anti-leak adaptor for the refrigerant system of FIG. 1, according to the present invention.

FIG. 7 is a side view of the anti-leak adaptor of FIG. 6, according to the present inventions.

FIG. 8 is a sectional view of the anti-leak adaptor of FIG. 6 taken along lines 8-8, according to the present inventions.

### DESCRIPTION OF THE PREFERRED EMBODIMENT(S)

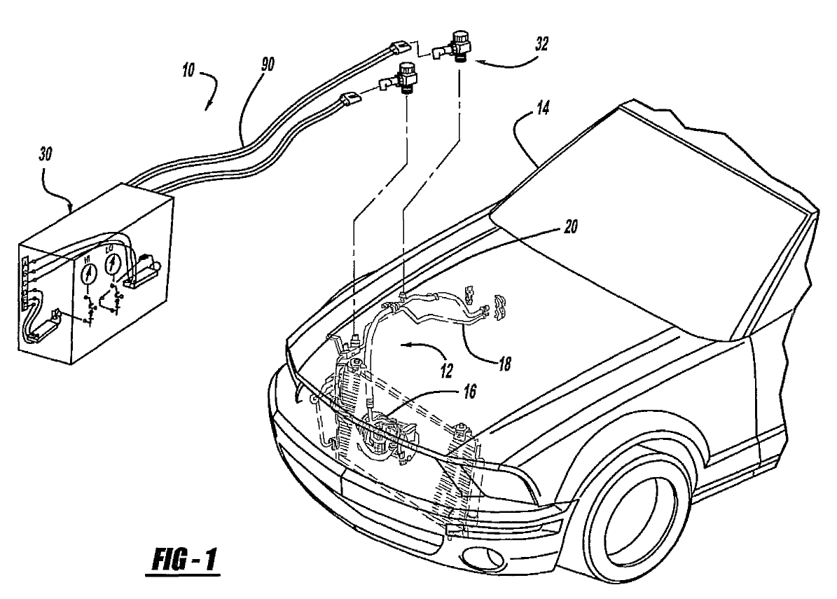

Referring to FIG. 1, a system 10 for evaluating the operation of the air conditioning system 12 on a vehicle 14 is illustrated. The air conditioning evaluation system 10 can be utilized in performing various types of tests of the vehicle air conditioning system 12. One example of a test is a static test of the air conditioning system 12 in an environmental chamber. Another example of a test is a dynamic road test of the air conditioning system 12.

The air conditioning system 12 is part of the air-handling system for the vehicle 14, and in particular provides conditioned air to the passenger compartment of the vehicle 12. The air conditioning system 12 includes components 16 such as a compressor, a condenser, an evaporator, pressure valves, and lines 18 interconnecting these components 16. The lines transport a refrigerant, such as R134a, or the like.

The air conditioning evaluation system 10 includes a service valve 20 disposed in an aperture in one of the lines 18 of the air conditioning system 12. In this example, the service valve 20 is a port providing access to the air conditioning system. Access is desirable in situations such as testing or servicing of the air conditioning system, or the like. Various types of service valves 20 are known in the art, such as model number 041206, series M8, M10, JRALO, JRAHI or COM manufactured by Schrader-Bridgeport. As shown in. FIG. 2, the service valve 20 includes features such as a housing 22, a passageway 24 formed within the housing, and a valve stem 26 for opening and closing of the passageway 24. An interior surface of the service valve is threaded as shown at 28, for connection purposes.

The air conditioning evaluation system 10 also includes a data processing means 30 that acquires the data gathered during the air conditioning system evaluation. In this example, the data processing means is a data acquisition processor that includes a processor, a memory and an input and an output. An example of a memory is a data storage device, including a fixed memory device, such as a hard drive or the like. Another example of a memory is a removable memory device, such as a memory stick, scan disc, compact disc or the like. There may be more than one memory means associated with the processor. Alternatively, the memory is a remotely located data storage device that is in communication with the processor via a communications network. In addition, the memory may include a database of information that is beneficial to performing the air-conditioning system evaluation.

The air conditioning evaluation system 10 includes an adaptor 32 operatively connected to the service valve 20 that is utilized to actuate the service valve in order to access the air conditioning system 12. As shown in the example of FIG. 2, the adaptor 32 includes an adaptor body 34 having a wall forming a generally cylindrical shape. It should be appreciated that other suitable shapes may be utilized, such as cubical or the like. The adaptor body 34 is made from a material, such as aluminum. The adaptor body 34 has a first end and an opposed second end. An interior portion of the adaptor body 34 forms a central passageway 40, extending from an opening in the first end 36 of the adaptor body 34 to an opening in the second end 38. The first end 36 of the adaptor body 34 is configured to interconnect with the service valve 20. The second end 38 of the adaptor body is configured to receive a sensing means (to be described).

An outermost edge of the first end 36 of the adaptor body 34 includes a lip 42 that extends radially outward. An outer surface of the first end 36 of the adaptor body 34 that is adjacent the lip 42 includes a guide portion 44 for directing the adaptor into the service valve passageway 24. An outer surface of the first end 36 of the adaptor body 34 that is adjacent the guide portion 44 is threaded 46. The threaded portion 46 of the adaptor body 34 is configured to be threadingly engaged within the corresponding threaded portion 28 of the service valve 20, in order to connect the adaptor 32 to the service valve 22.

The adaptor 32 includes a sealing means 48, such as an o-ring, positioned over the outer surface of the first end 36 of the adaptor body 34, between the guide portion 44 and a first thread of the threaded portion 46. The sealing means 48 is made from a material such as rubber, HNBR or neoprene w or the like. It should be appreciate that the sealing means 48 may be located within an annular groove in the adaptor body 34. The adaptor 32 may include a plurality of sealing means 48 positioned to avoid any leakage of refrigerant.

The adaptor 32 includes a knob 50 positioned over a mid-portion of the adaptor body 34. In this example the knob 50 is a nut having a plurality of faceted side walls. The knob 50 is operatively connected to a plunger 52 disposed within the central passageway 40 in the adaptor body 34. The plunger 52 is oriented longitudinally in the central passageway 40. In this example, the plunger 52 is a tubular member, with a first end having a radially extending lip 54. and a second end that is operatively connected to the knob 50. It should be appreciated that rotation of the knob 50 in a clockwise direction causes the displacement of the plunger 52 in an outboard direction, so as to contact a corresponding valve stem in the service valve 22, in order to open the service valve 22 for testing purposes. Likewise, to close the service valve, the knob 50 is rotated in a counterclockwise direction to displace the plunger 52 in the opposite direction.

The second end 38 of the adaptor body includes a fitting 56 configured to receive a sensing means 58. In this example, the fitting 56 is integral with the adaptor body and includes a housing that has a cylindrical shape. The interior of the fitting 56 includes a passageway (not shown) that is in communication with the central passageway 40 in the adaptor body 34. At least a portion of the interior wall of the passageway fitting may be threaded in order to engage a corresponding threaded portion of the sensing means 58.

The air conditioning evaluation system 10 includes a sensing means 58 operatively connected to the adaptor 32. In this example the sensing means 58 is an electronic sensor for sensing pressure of the refrigerant. An example of such a sensor 58 is model number 2CP45-1(HI) and EX3402-1652(LO) manufactured by Texas Instruments. The sensing means 58 includes an engagement portion for connecting the sensing means 58 to the fitting portion of the adaptor. In this example, an outer surface of the sensing means engagement portion is threaded, for engagement with the inner threaded wall of the fitting 56. Other types of engagements are contemplated, such as a male/female connection or the like. The sensing means 58 is in communication with the data processing means via a communication means 90. The communication means 90 may be a wired link or a wireless link for transmitting a signal from a corresponding sensing means 58.

In operation, the sensing means 58 is connected to the adaptor body. The guide portion 44 of the adaptor body 34 is positioned within the open, receiving end of the service valve 20. The knob 50 is rotated in a clockwise direction, to threadingly engage the adaptor threaded portion 46 with the threaded portion 28 of the service valve housing 22. Further rotation of the knob 50 causes the adaptor plunger 52 to push against the service valve stem 26, in order to open the service valve 20. Opening of the service valve 20 provides access to the air conditioning system 12 for testing purposes, so that the sensing means 58 can transfer data to the data controller 30 via the communications link 90 in a predetermined manner.

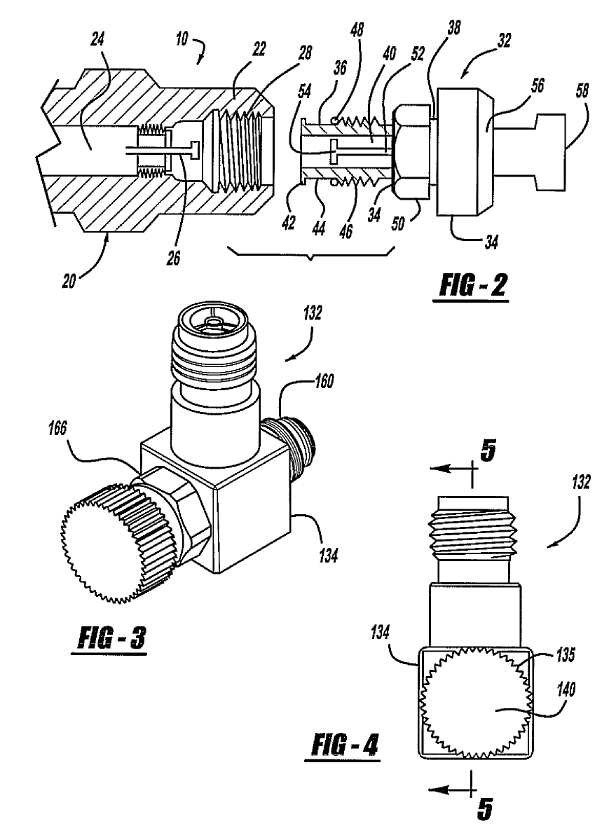

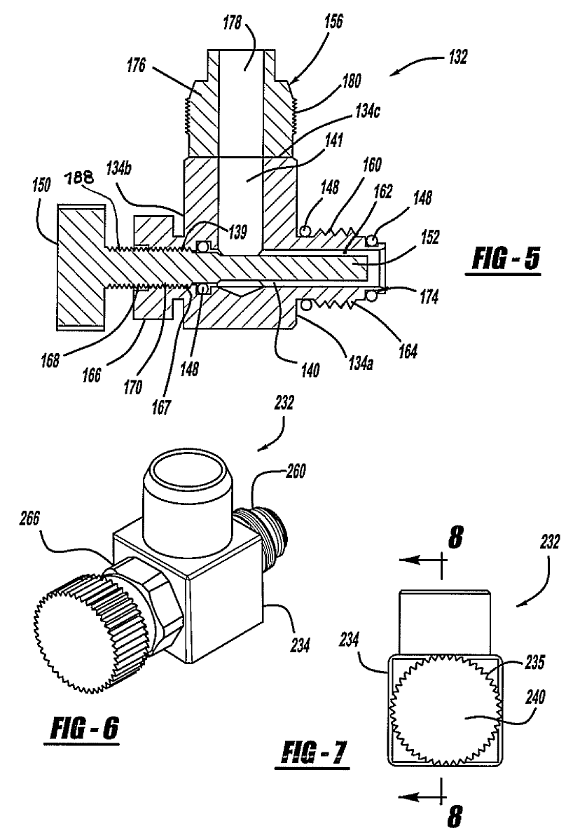

Referring to FIGS. 3-5, another embodiment of an adaptor 132 that may be operatively connected to the service valve 22 to provide access to the air conditioning system 12 is illustrated. It should be appreciated that like features have like reference numerals increased by 100. As shown in FIG. 3, the adaptor 132 includes an adaptor body 134 having a generally cubical shape. Two parallel walls of the adaptor body 134 each include an opening 135. An interior portion of the adaptor body 134 forms a first central passageway 140, extending from the opening 135 in the first wall 134a of the adaptor body 134 to an opening 135 in the opposed second wall 134b of the adaptor body 134.

The interior portion of the adaptor body 134 also includes a second passageway 141, extending between an opening in a third wall 134c that is perpendicular to the first and second walls 134a, 134b, and the first central passageway 140. It should be appreciated that the first passageway 140 is perpendicular to the second passageway 141. The adaptor body 134 is made from a metal material, such as aluminum.

The adaptor 132 includes an integrally formed first fitting 160 that is adjacent the opening in the first wall 134a of the adaptor body 134. In this example, the first fitting 160 is generally cylindrical, and has a central passageway 162 that is contiguous with the central passageway 140 of the adaptor valve body 134. The first fitting 160 is configured to be fittingly engaged within the open end of the service valve 20. An outer surface of the first fitting is threaded 164, so as to be threadingly engaged within the threaded opening of the service valve 20.

The adaptor 132 further includes second fitting 166 located adjacent the second wall 134b of the adaptor body 134. The second fitting 166 may be integral with the adaptor body 132, or a separable member. As shown in this example, the second fitting includes a threaded portion 167 that is threadingly engaged by a corresponding threaded portion in the central passageway 140 of the adaptor body, as shown at 139. The second fitting 166 includes a collar portion having a central passageway 168 and that is contiguous with the first passageway 140 of the adaptor body 134. A portion of the second fitting passageway 168 may be threaded, as shown at 170. A knob 150 is operatively connected to the second fitting 166. An outer surface of the knob 150 may be knurled for ease of operation. The knob 150 is operatively connected to a plunger 152 that is disposed within the adaptor body first passageway 140. The plunger 152 is oriented longitudinally in the first passageway 140. In this example, the plunger 152 is a tubular member, and is integral and one with the knob 150. A portion of the outer surface of the plunger 152 is threaded as shown at 188, for threaded engagement of the knob in the corresponding threads 170 of the second fitting 166. It should be appreciated that rotation of the knob 150 in a clockwise direction causes the displacement of the plunger 152 towards the service valve 20, so as to contact a corresponding valve stem in the service valve 20, in order to open the service valve 20. Likewise, rotation of the knob in the counterclockwise direction displaces the plunger 152 away from the service valve, in order to close the service valve 20.

The adaptor 132 includes a sealing means 148, such as an o-ring. In this example, there is an o-ring adjacent the second opening, so as to prevent any leakage of refrigerant when the service valve 20 is open. There may be another o-ring 148 positioned over the first fitting 160 and adjacent the adaptor body 134, and still another o-ring 148 positioned at an outer end of the first fitting 160, adjacent the first thread of the threaded portion. It should be appreciated that the o-ring may be disposed in an annular groove, as shown at 174.

The adaptor 132 includes an integrally formed fitting 156 configured for receiving the sensing means 58, as previously described. The fitting 156 extends outwardly from the third wall 134c of the adaptor body 134. In this example, the sensing means fitting 156 includes a housing 176 that has a cylindrical shape. The interior of the sensing means fitting 156 includes a passageway 178 that is contiguous with the second passageway 141 in the adaptor body 134. At least a portion of an outer surface of the sensing means fitting 156 is threaded as shown at 180, in order to engage a corresponding threaded portion of the sensing means 58. Other types of engagements are contemplated, as previously described.

In operation, the sensing means 58 is connected to the adaptor body. The first fitting 160 is positioned within the open end of the service valve 32 and threaded onto the corresponding threaded surface 28 of the service valve 20. To access the refrigerant the knob 150 is rotated in a clockwise direction, causing the adaptor plunger 152 to push against the service valve stem 26, in order to actuate the service valve 20 and provide access to the air conditioning system for testing purposes. The sensing means 58 transfers data in a predetermined manner. To discontinue actuation of the service valve 20, the knob 150 is rotated in a counterclockwise direction, to displace the plunger 152 in a direction away from the service valve stem 26, in order to close the service valve 20.

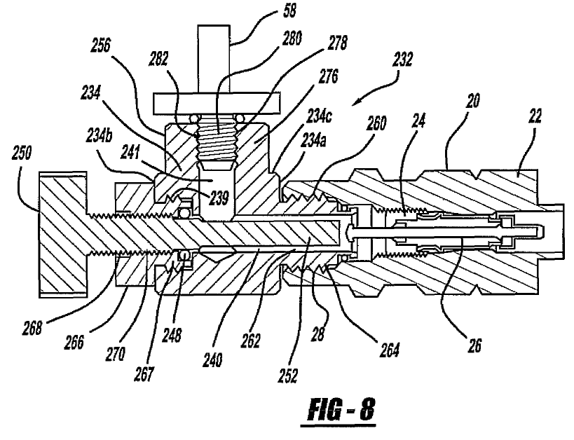

Referring to FIGS. 6-8, another embodiment of an adaptor 232 that may be operatively connected to the service valve 22 to provide access to the air conditioning system 12 is illustrated. It should be appreciated that like features have like reference numerals increased by 200. As shown in FIG. 6, the adaptor 232 includes an adaptor body 234 having a generally cubical shape. Two parallel walls of the adaptor body 234 each include an opening 235. An interior portion of the adaptor body 234 forms a first central passageway 240, extending from the opening 235 in the first wall 234a of the adaptor body 234 to an opening 235 in the opposed second wall 234b of the adaptor body 234.

The interior portion of the adaptor body 234 also includes a second passageway 241, extending from a third wall 234c having a third opening to the first central passageway 240. It should be appreciated that the second passageway 241 is perpendicular to the first passageway 240. The adaptor body 234 is made from a metal material, such as aluminum.

The adaptor 232 includes an integrally formed first fitting 260 that is adjacent the opening in the first wall 234a of the adaptor body 234. In this example, the first fitting 260 is generally cylindrical, and has a central passageway 262 that is contiguous with the central passageway 240 of the adaptor valve body 234. The first fitting 260 is configured to be fittingly engaged within the open end of the service valve 20. An outer surface of the first fitting is threaded as shown at 264, so as to be threaded into the threaded opening of the service valve 20.

The adaptor 232 includes a second fitting 266 located adjacent the second wall 234b of the adaptor body 234. The second fitting may be integral with the adaptor body 232, or a separable member. As shown in this example, the second fitting includes a threaded portion 267 that is threadingly engaged by a corresponding threaded portion in the central passageway 240 of the adaptor body, as shown at 239. The second fitting 266 includes a collar portion having a central passageway 268 that is contiguous with the first passageway 240 of the adaptor body 234. A portion of the second fitting is threaded, as shown at 270. A knob 250 is operatively connected to the second fitting 266. In this example, the second fitting is a nut. An outer surface of the knob 250 may be knurled for ease of operation. The knob 250 is operatively connected to a plunger 252 extending perpendicular to the knob 250. The plunger 252 is disposed within the adaptor body first passageway 240, and is oriented longitudinally. In this example, the plunger 252 is a tubular member, and is integral and one with the knob 250. A portion of the outer surface of the plunger 252 is threaded as shown at 288, for threaded engagement of the knob 250 in the corresponding threads 270 of the second fitting 266. It should be appreciated that rotation of the knob 250 causes the displacement of the plunger 252 in an outboard direction, so as to contact a corresponding valve stem 26 in the service valve 20, in order to actuate the service valve 20. Likewise, rotation of the knob in the counterclockwise direction displaces the plunger 252 away from the service valve 20, in order to close the service valve.

The third wall 234c of the adaptor body 234 includes an integrally formed fitting 256 that is configured for receiving the sensing means 58. In this example, the sensing means fitting 256 is configured to be cylindrical, although other shapes are contemplated. The sensing means fitting 256 includes, a central passageway 278 that is contiguous with the second passageway 241 in the adaptor body 234. At least a portion of an inner surface of the central passageway is threaded as shown at 282, in order to engage a corresponding threaded portion of the sensing means 258. Other types of engagements are contemplated, as previously described. A sealing means 248, such as the previously described o-ring, may be utilized to further ensure that there is no leakage of refrigerant.

In operation, the sensing means 58 is threaded into the sensing means fitting 256. The first fitting 260 is positioned within an open end of the service valve 32 and threaded onto the corresponding threaded surface 28 of the service valve 20. To access the refrigerant, the knob 250 is rotated in a clockwise direction, causing the adaptor plunger 252 to push against the service valve stem 26, in order to actuate the service valve 20. Opening of the service valve plunger provides access to the air conditioning system 12 and the sensing means 58 may transfer data in a predetermined manner. To discontinue actuation of the service valve, the knob 250 is rotated in a counterclockwise direction, to displace the plunger 252 away from the service valve stem 26, in order to close the service valve 20.

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the present invention may be practiced other than as specifically described.

1. A anti-leak adaptor for use in a vehicle during an air conditioning system evaluation, said adaptor comprising:
a cylindrically shaped adaptor body having a first end and a second end and a central passageway extending between an opening in the first end to an opening in the second end, wherein said first end includes a guide portion and a threaded portion that is adjacent the guide portion;
a knob positioned on a mid-portion of the adaptor body, wherein said knob is operatively connected to a plunger disposed within the central passageway in said adaptor body and oriented longitudinally towards the opening in said first end;
a fitting connected to said second end of said adaptor body for receiving a sensing means.

2. The anti-leak adaptor of claim 1 further comprising a sealing means positioned over an outer surface of said first end of said adaptor body.

3. The anti-leak adaptor of claim 1 wherein said fitting includes a housing having a cylindrical shape, and said sensing means is threadingly connected to said fitting.

4. The anti-leak adaptor of claim 1 wherein said guide portion of said adaptor body is operatively connected to a receiving end of a service valve disposed in a line in a vehicle air conditioning system, and rotation of said knob displaces said plunger to actuate said service valve.

5. An anti-leak adaptor for use in a vehicle during an air conditioning system evaluation, said adaptor comprising:
an adaptor body having a cubical shape, with a first wall, an opposed second wall, and a third wall that is perpendicular to said first and second walls, and each of the walls includes an opening, wherein a first passageway extends between the first opening in the first wall to the second opening in the second wall, and a second passageway extends between the third opening in said third wall and first passageway;
a first fitting adjacent to the first opening in said first wall of the adaptor body, wherein said first fitting is generally cylindrical and includes a passageway that is contiguous with the first passageway in the adaptor body;
a second fitting located adjacent said second wall of said adaptor body, wherein said second fitting includes a passageway that is contiguous with the first passageway in the adaptor body;
a knob operatively connected to said second fitting, wherein said knob includes a plunger disposed within the central passageway in said adaptor body and oriented longitudinally towards the first opening in said first wall; and
a third fitting connected to said third wall of said adaptor body for receiving a sensing means.

6. The anti-leak adaptor of claim 5 further comprising a sealing means positioned over an outer surface of said first end of said adaptor body.

7. The anti-leak adaptor of claim 5 wherein said third fitting includes a housing having a cylindrical shape, and an outer surface of said fitting is threaded and said sensing means is threadingly connected to said fitting.

8. The anti-leak adaptor of claim 5 wherein said third fitting includes a housing having a cylindrical shape, and an inner surface of said fitting is threaded and said sensing means is threadingly connected to said fitting.

9. The anti-leak adaptor of claim 5 wherein an outer surface of said first fitting is threaded, and said first fitting is threadably connected to a receiving end of a service valve disposed in a line in a vehicle air conditioning system, and rotation of said knob displaces said plunger to actuate said service valve.

10. An anti-leak adaptor for use in a vehicle during an air conditioning system evaluation, said adaptor comprising:
an adaptor body having a cubical shape, with a first wall, an opposed second wall, and a third wall that is perpendicular to said first and second walls, and each of the walls includes an opening, wherein a first passageway extends between the first opening in the first wall to the second opening in the second wall, and a second passageway extends between the third opening in said third wall and first passageway;
a first fitting adjacent to the first opening in said first wall of the adaptor body, wherein said first fitting is generally cylindrical and includes a passageway that is contiguous with the first passageway in the adaptor body, and an outer surface of said first fitting is threaded;
a second fitting located adjacent said second wall of said adaptor body, wherein said second fitting includes a passageway that is contiguous with the first passageway in the adaptor body;
a knob operatively connected to said second fitting, wherein said knob includes a plunger disposed within the central passageway in said adaptor body and oriented longitudinally towards the first opening in said first wall; and
a third fitting connected to said third wall of said adaptor body for receiving a sensing means, wherein said first fitting is threadably connected to a receiving end of a service valve disposed in a line in a vehicle air conditioning system, and rotation of said knob displaces said plunger to actuate said service valve.

11. The anti-leak adaptor of claim 10 further comprising a sealing means positioned over an outer surface of said first end of said adaptor body.

12. The anti-leak adaptor of claim 10 wherein said third fitting includes a housing having a cylindrical shape, and an outer surface of said fitting is threaded and said sensing means is threadingly connected to said fitting.

13. The anti-leak adaptor of claim 10 wherein said third fitting includes a housing having a cylindrical shape, and an inner surface of said fitting is threaded and said sensing means is threadingly connected to said fitting.
